(19) United States
(12) Patent Application Publication
(10) Pub. No.: US 2012/0304949 A1
(43) Pub. Date: Dec. 6, 2012

(54) INTERNAL COMBUSTION ENGINE

(75) Inventor: Takeshi Ashizawa, Yokohama-shi (JP)

(73) Assignee: TOYOTA JIDOSHA KABUSHIKI KAISHA, Toyota-shi, Aichi (JP)

(21) Appl. No.: 13/375,408

(22) PCT Filed: Jun. 1, 2011
(86) PCT No.: PCT/JP2011/063090

§ 371 Date: Nov. 30, 2011

(51) Int. Cl. B60H 1/03

(52) U.S. Cl. 123/142.5 R

(57) ABSTRACT

The internal combustion engine is provided with a variable volume device which uses the change of pressure of the combustion chamber as the drive source, when the pressure of the combustion chamber reaches a predetermined control pressure, and changes the volume of the space communicated with the combustion chamber by compression of the spring device. The spring device includes a tubular part which communicates with the combustion chamber and a movement member which is arranged movably inside the tubular part. The variable volume device includes a heating device which is formed so as to be able to heat a region, in the wall surface of the tubular part, forming a space communicating with the combustion chamber when the movement member moves.

### TECHNICAL FIELD

The present invention relates to an internal combustion engine.

### BACKGROUND ART

An internal combustion engine supplies a combustion chamber with fuel and air and burns the fuel in the combustion chamber to output a drive force. When burning fuel in the combustion chamber, the air-fuel mixture of the air and fuel is compressed in state. It is known that the compression ratio of the internal combustion engine has an effect on the output and fuel consumption. By raising the compression ratio, it is possible to increase the output torque or reduce the fuel consumption. In this regard, if making the compression ratio extremely high, it is known that abnormal combustion occurs in the combustion chamber.

Japanese Patent Publication (A) No. 2000-230439 discloses a self-ignition type internal combustion engine which provides a combustion chamber with a sub chamber which is communicated through a pressure regulator, wherein the pressure regulator has a valve element and a valve shaft which is connected to the valve element and is biased to the combustion chamber side. It is disclosed that this self igniting type internal combustion engine pushes up the pressure regulator against the pressure of an elastic member and releases the pressure to the sub chamber when overly early ignition etc. causes the combustion pressure to exceed a predetermined allowable pressure value. This publication discloses a pressure regulator which operates by a pressure larger than the pressure which occurs due to overly early ignition etc. Further, in this publication, an internal combustion engine is disclosed where a sub chamber is formed which communicates with the combustion chamber and a sub piston is inserted able to move vertically in the sub chamber. The sub piston is pressed against by a mechanical spring. It is disclosed that when the fuel is burned, the pressure of the combustion chamber causes the mechanical spring to be compressed and the sub piston to rise and the volume of the sub chamber which communicates with the combustion chamber becomes larger.

Further, WO2011/030471 discloses a combustion pressure control system which is provided with a variable volume device which has a sub chamber communicated with a combustion chamber and which changes the volume of the sub chamber when the pressure of combustion chamber reaches the control pressure. In this variable volume device, a sub chamber use piston for forming a sub chamber is disclosed as being pushed by a gas.

### CITATION LIST

### Patent Literature

PLT 1: Japanese Patent Publication (A) No. 2000-230439
PLT 2: WO2011/030471

### SUMMARY OF INVENTION

### Technical Problem

In a device adjusting the pressure of a combustion chamber which is disclosed in Japanese Patent Publication (A) No. 2000-230439, if fuel is burned in the combustion chamber, the sub piston moves in a direction away from the combustion chamber. At this time, a sub chamber which is communicated with the combustion chamber becomes larger. After that, a piston in the cylinder descends and the pressure of the combustion chamber falls, whereby the sub piston moves toward the combustion chamber and returns to the original position. Due to the operation of the device controlling the pressure of the combustion chamber, high temperature combustion gas flows to the inside of the sub chamber communicated with the combustion chamber.

The internal combustion engine which is disclosed in the above publication has the sub chamber formed inside of the cylinder head. For this reason, the heat of the combustion gas is radiated through the wall surface of the sub chamber to the cylinder head. Due to the operation of the device controlling the pressure of the combustion chamber, the area from which the heat of the combustion gas is radiated is enlarged. For this reason, due to the operation of the device controlling the pressure of the combustion chamber, the cooling loss is increased. As a result, the torque which is output was suppressed or the drop of the fuel consumption was suppressed.

The present invention has as its object the provision of an internal combustion engine which is provided with a device which controls the pressure of a combustion chamber and which suppresses cooling loss.

### Solution to Problem

The internal combustion engine of the present invention is provided with a variable volume device which includes a spring device which has elasticity and, when the pressure of a combustion chamber reaches a predetermined control pressure, uses the change in pressure of the combustion chamber as a drive source so that the spring device is compressed whereby the volume of a space communicated with the combustion chamber changes. The spring device includes a tubular part which communicates with the combustion chamber and a movement member which is arranged movably inside the tubular part. The movement member divides a space at the inside of the tubular part, whereby a space is formed communicated with the combustion chamber. The variable volume device includes a heating device which is arranged around the tubular part. The heating device is formed so as to be able to heat the region, in the wall surface of the tubular part, forming the space communicated with the combustion chamber when the movement member moves.

In the above invention, preferably the heating device is arranged around the region forming the space communicated with the combustion chamber when the movement member moves.

In the above invention, preferably the spring device has a gas chamber which is formed at a side opposite to the side facing the combustion chamber by the movement member dividing a space inside of the tubular part, the movement member is pressed against by pressurized gas being sealed in the gas chamber, and the heating device is formed avoiding the surroundings of the region continuously forming the gas chamber during movement of the movement member.

In the above invention, preferably the variable volume device has a heat insulating structure which is arranged between the heating device and the combustion chamber and which suppresses movement of heat from the heating device to the inside of the combustion chamber.

In the above invention, preferably the variable volume device is arranged inside of the cylinder head which includes the top face of each combustion chamber, the tubular part is fastened to the cylinder head, and the heat insulating structure includes a heat insulating member with a smaller heat conductivity than the cylinder head or a closed space with a cavity inside it.

### Advantageous Effects of Invention

According to the present invention, it is possible to provide an internal combustion engine which is provided with a device which controls the pressure of a combustion chamber and which suppresses cooling loss.

### BRIEF DESCRIPTION OF DRAWINGS

FIG. 1 is a schematic view of an internal combustion engine in an embodiment.

FIG. 2 is a schematic view of a variable volume device and pressure changing device of an internal combustion engine in an embodiment.

FIG. 3 is a graph showing the relationship between a crank angle and a pressure of a combustion chamber in an internal combustion engine in an embodiment.

FIG. 4 is an enlarged schematic cross-sectional view of a variable volume device which has a first heating device in an embodiment.

FIG. 5 is an enlarged schematic cross-sectional view of a variable volume device which has a second heating device in an embodiment.

FIG. 6 is an enlarged schematic cross-sectional view of a variable volume device which has a third heating device in an embodiment.

FIG. 7 is an enlarged schematic cross-sectional view of a variable volume device which has a fourth heating device in an embodiment.

FIG. 8 is an enlarged schematic cross-sectional view of a variable volume device which has a fifth heating device in an embodiment.

FIG. 9 is an enlarged schematic cross-sectional view of a variable volume device which has a sixth heating device in an embodiment.

FIG. 10 is another enlarged schematic cross-sectional view of a variable volume device which has a sixth heating device in an embodiment.

FIG. 11 is an enlarged schematic cross-sectional view of a variable volume device which has a seventh heating device in an embodiment.

### DESCRIPTION OF EMBODIMENTS

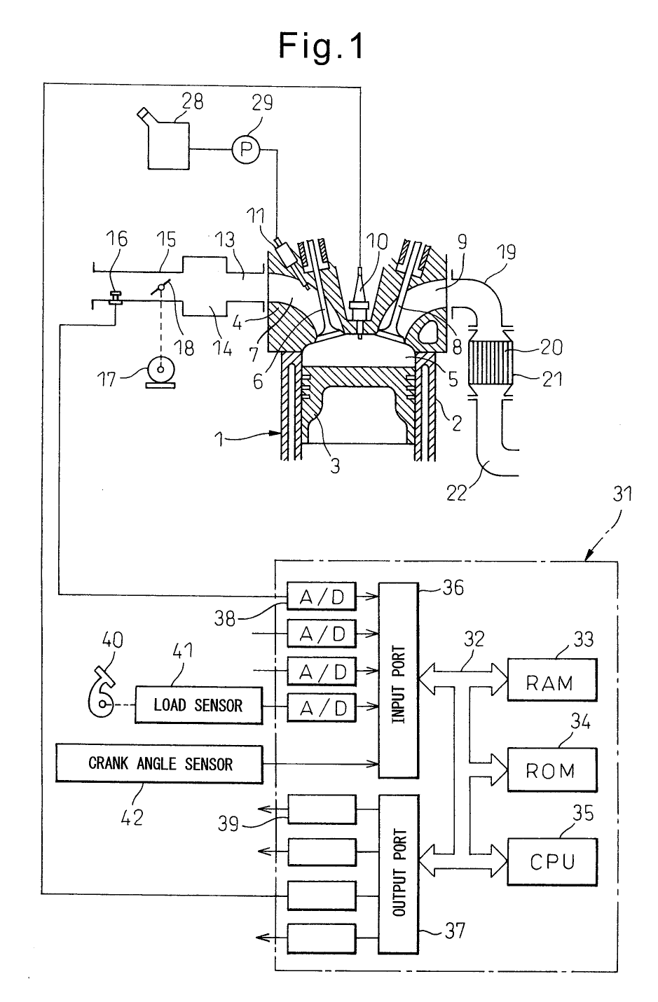

Referring to FIG. 1 to FIG. 11, an internal combustion engine in an embodiment will be explained. In the present embodiment, the explanation will be given with reference to the example of an internal combustion engine which is mounted in a vehicle.

FIG. 1 is a schematic view of an internal combustion engine in the present embodiment. The internal combustion engine in the present embodiment is a spark ignition type. The internal combustion engine is provided with an engine body 1. The engine body 1 includes a cylinder block 2 and cylinder head 4. Inside the cylinder block 2, pistons 3 are arranged. In the present invention, the space inside a cylinder surrounded by the crown surface of the piston and the cylinder head when the piston reaches compression top dead center is referred to as the “combustion chamber”. In addition the space inside of the cylinder surrounded by the crown face of the piston and the cylinder head at any position will also be referred to as the “combustion chamber”. The top face of the combustion chamber 5 is formed by the cylinder head 4, while the bottom face of the combustion chamber 5 is formed by the crown face of the piston 3.

A combustion chamber 5 is formed for each cylinder. Each combustion chamber 5 is connected to an engine intake passage and an engine exhaust passage. At the cylinder head 4, an intake port 7 and exhaust port 9 are formed. An intake valve 6 is arranged at an end of the intake port 7 and is formed to be able to open and close the engine intake passage which is communicated with the combustion chamber 5. An exhaust valve 8 is arranged at an end of the exhaust port 9 and is formed to be able to open and close the engine exhaust passage which is communicated with the combustion chamber 5. At the cylinder head 4, a spark plug 10 is fastened. The spark plug 10 is formed to ignite the fuel in the combustion chamber 5.

The internal combustion engine in the present embodiment is provided with a fuel injector 11 for feeding fuel to each combustion chamber 5. The fuel injector 11 in the present embodiment is arranged so as to inject fuel to the intake port 7. The fuel injector 11 is not limited to this. It is sufficient that it be arranged to be able to feed fuel to the combustion chamber 5. For example, the fuel injector may be arranged so as to directly inject fuel to the combustion chamber.

The fuel injector 11 is connected to a fuel tank 28 through an electronic control type variable discharge fuel pump 29. The fuel which is stored in the fuel tank 28 is supplied to the fuel injector 11 by the fuel pump 29.

The intake port 7 of each cylinder is connected through a corresponding intake runner 13 to a surge tank 14. The surge tank 14 is connected through an intake duct 15 to an air cleaner (not shown). At the inside of the intake duct 15, an air flowmeter 16 is arranged to detect the amount of intake air. Further, at the inside of the intake duct 15, a throttle valve 18 which is driven by a step motor 17 is arranged. On the other hand, the exhaust port 9 of each cylinder is connected to a corresponding exhaust runner 19. The exhaust runner 19 is connected to a catalytic converter 21. The catalytic converter 21 in the present embodiment includes a three-way catalyst 20. The catalytic converter 21 is connected to an exhaust pipe 22.

The internal combustion engine in the present embodiment is provided with an electronic control unit 31. The electronic control unit 31 in the present embodiment includes a digital computer. The electronic control unit 31 includes components connected to each other through a bidirectional bus 32 such as a RAM (random access memory) 33, ROM (read only memory) 34, CPU (microprocessor) 35, input port 36, and output port 37.

The air flowmeter 16 generates an output voltage which is proportional to the amount of intake air which is taken into each combustion chamber 5. This output voltage is input to the input port 36 through a corresponding AD converter 38. An accelerator pedal 40 has a load sensor 41 connected to it. The load sensor 41 generates an output voltage which is proportional to the amount of depression of the accelerator pedal 40. This output voltage is input through a corresponding AD converter 38 to the input port 36.

A crank angle sensor 42 generates an output pulse every time a crankshaft for example turns by a predetermined angle. This output pulse is input to the input port 36. The output of the crank angle sensor 42 may be used to detect the engine speed. Further, the output of the crank angle sensor 42 may be used to detect the crank angle.

The output port 37 of the electronic control unit 31 is connected through corresponding drive circuits 39 to each fuel injector 11 and spark plug 10. The electronic control unit 31 in the present embodiment is formed so as to control fuel injection and control ignition. That is, the timing of injection of fuel and the amount of injection of fuel are controlled by the electronic control unit 31. Further the ignition timing of each spark plug 10 is controlled by the electronic control unit 31. Further, the output port 37 is connected through the corresponding drive circuits 39 to the step motor 17 for driving the throttle valve 18 and the fuel pump 29. These devices are controlled by the electronic control unit 31.

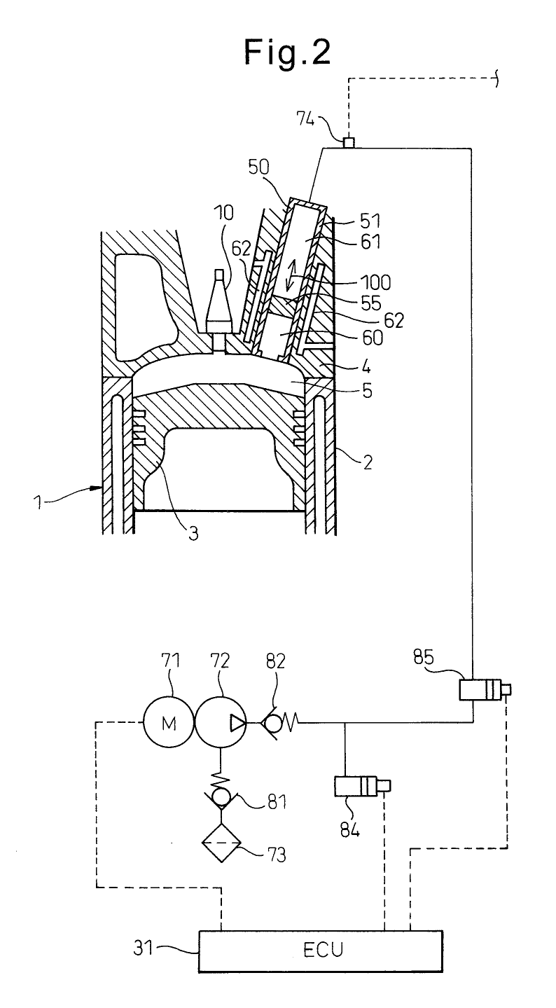

FIG. 2 shows a schematic cross-sectional view of a variable volume device and pressure changing device in an internal combustion engine in the present embodiment. The internal combustion engine in the present embodiment is provided with a combustion pressure control system which controls the pressure of each combustion chamber when the fuel is burned. The combustion pressure control system in the present embodiment is provided with a variable volume device by which the volume of the space communicated with the combustion chamber changes. The variable volume device includes a gas spring 50. The gas spring 50 is connected to each combustion chamber 5 in each cylinder. The internal combustion engine in the present embodiment has a sub chamber 60 as the space which is communicated with each combustion chamber 5.

The variable volume device in the present embodiment uses the pressure change of each combustion chamber 5, when the pressure of the combustion chamber 5 reaches the control pressure, as the drive source to change the volume of the sub chamber 60. That is, the variable volume device operates by the change of pressure of the combustion chamber 5. The control pressure in the present invention is defined as a pressure of the combustion chamber at the timing when the variable volume device starts to operate. That is, this is the pressure of the combustion chamber when the sub chamber use piston 55 starts to move. The variable volume device keeps the pressure of the combustion chamber 5 from becoming the pressure of occurrence of abnormal combustion or more.

The abnormal combustion in the present invention, for example, includes combustion other than the state when an ignition device ignites the air-fuel mixture and the combustion successively propagates from the ignition point. Abnormal combustion includes, for example, the knocking phenomenon, detonation phenomenon, and preignition phenomenon. The knocking phenomenon includes the spark knock phenomenon. The spark knock phenomenon is the phenomenon where fuel is ignited in a spark device, the flame spreads centered from the ignition device, and the air-fuel mixture including unburned fuel at the position furthest from the ignition device self ignites. The air-fuel mixture at the position far from the ignition device is compressed by the combustion gas near the ignition device, becomes high temperature and high pressure, and self ignites. When the air-fuel mixture self ignites, a shock wave is generated.

The detonation phenomenon is the phenomenon where the air-fuel mixture ignites due to a shock wave passing through the high temperature, high pressure air-fuel mixture. This shock wave is, for example, generated due to the spark knock phenomenon. The preignition phenomenon is also called the “early ignition phenomenon”. The preignition phenomenon is the phenomenon of metal at the tip of a spark plug or carbon sludge etc. deposited inside a combustion chamber being heated to a predetermined temperature or more and, in the state maintaining that, this part becoming the spark for ignition and burning of fuel before the ignition timing.

The variable volume device in the present embodiment is provided with a tubular member 51 forming each tubular part. The tubular member 51 in the present embodiment is formed into a cylindrical shape. Inside of the tubular member 51, a sub chamber use piston 55 is arranged as the movement member. The space inside of the tubular member 51 is divided by the sub chamber use piston 55. Inside of the tubular member 51, a sub chamber 60 is formed at the side facing the combustion chamber 5. Further, inside of the tubular member 51, a gas chamber 61 is formed at the side opposite to the side facing the combustion chamber 5.

Each sub chamber use piston 55 is not fixed to the tubular member 51 but is formed so as to move in the axial direction of the tubular member 51. The sub chamber use piston 55, as shown by the arrow 100, moves inside of the tubular member 51. The sub chamber use piston 55 contacts the tubular member 51 through piston rings serving as sealing members. Due to the movement of the sub chamber use piston 55, the volume of the sub chamber 60 changes. The combustion gas flows to the sub chamber 60.

The variable volume device in the present embodiment includes a spring device which has elasticity. The spring device in the present embodiment has a gas spring 50. The gas spring 50 is formed to have elasticity by sealing of gas inside it. A gas chamber 61 of the gas spring 50 is charged with a pressurized gas so that when the pressure of a combustion chamber 5 reaches the desired control pressure, the sub chamber use piston 55 will start to move. In the present embodiment, the gas chamber 61 is charged with air. The gas which is charged into the gas chamber 61 is not limited to air. Any gas may be employed.

In the internal combustion engine in the present embodiment, the pressure regulator 85 is closed while the sub chamber use piston 55 is moving, that is, while the gas spring 50 is being compressed. The gas spring 50 has elasticity due to the pressure regulator 85 being closed. Due to the pressure of the closed gas chamber 61, the sub chamber use piston 55 is pushed.

The internal combustion engine in the present embodiment is provided with a pressure changing device which changes the pressure of the gas chamber 61 of a gas spring. The pressure changing device in the present embodiment includes a motor 71 and a compressor 72 which is driven by the motor 71. At the outlet of the compressor 72, a check valve 82 is arranged. The check valve 82 prevents gas in the gas chamber 61 from flowing back and out. At the compressor 72, a check valve 81 and a filter 73 are connected. The filter 73 removes foreign matter from air which is sucked into the compressor 72. The check valve 81 prevents air from flowing back from the compressor 72.

The pressure changing device in the present embodiment includes a pressure sensor 74 as a pressure detector which detects the pressure of the gas chamber 61 of a gas spring 50. The pressure sensor 74 in the present embodiment is arranged at the flow path which connects the gas chamber 61 and the pressure regulator 85.

The pressure changing device is controlled by the electronic control unit 31. In the present embodiment, the motor 71 is controlled by the electronic control unit 31. The air discharge valve 84 and pressure regulator 85 in the present embodiment are controlled by the electronic control unit 31. The output of the pressure sensor 74 is input to the electronic control unit 31.

The internal combustion engine in the present embodiment enables air to be replenished even if air leaks out from the gas chamber 61 of a gas spring 50 while the engine is operating or while the engine is stopped. For example, the motor 71 drives the compressor 72 and, further, opens the pressure regulator 85 so as to supply air to the gas chamber 61.

The pressure changing device in the present embodiment enables the pressure of the gas chamber 61 of a gas spring 50 to be raised. Furthermore, the pressure changing device in the present embodiment can discharge gas from the gas chamber 61 of the gas spring 50. By opening the pressure regulator 85 and the air discharge valve 84, it is possible to lower the pressure of the gas chamber 61. By changing the pressure of the gas chamber 61, it is possible to change the control pressure. The pressure changing device is not limited to this. It is also possible to employ any device able to change the pressure of the gas chamber of a gas spring.

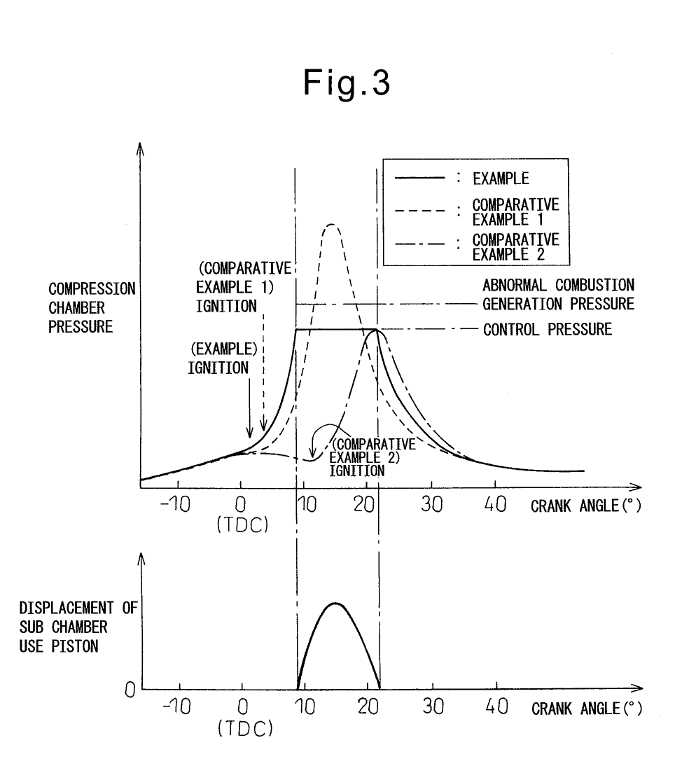

FIG. 3 shows a graph of the pressure of a combustion chamber in the internal combustion engine of the present embodiment. The abscissa indicates the crank angle, while the ordinate indicates the pressure of combustion chamber and the displacement of a sub chamber use piston. FIG. 3 shows a graph of the compression stroke and expansion stroke in the combustion cycle. The sub chamber use piston 55 has zero displacement when seated at the bottom of the tubular member 51. In the variable volume device in the present embodiment, the sub chamber use piston 55 moves when the pressure of the combustion chamber reaches the control pressure in the period from the compression stroke to the expansion stroke of the combustion cycle. As a result, the volume of the sub chamber 60 of the gas spring 50 becomes larger.

Referring to FIG. 2 and FIG. 3, at the time of start of the compression stroke, the sub chamber use piston 55 is seated at the bottom of the tubular member 51. In the compression stroke, the piston 3 rises and the pressure of the combustion chamber 5 rises. Here, in the gas chamber 61 of the gas spring 50, gas of a pressure corresponding to the control pressure is sealed, so the sub chamber use piston 55 is held in the seated state until the pressure of the combustion chamber 5 becomes the control pressure.

In the embodiment shown in FIG. 3, ignition is performed at a crank angle slightly after 0° (TDC). Due to the ignition, the pressure of the combustion chamber 5 rapidly rises. When the pressure of the combustion chamber 5 reaches the control pressure, the sub chamber use piston 55 starts to move. While the air-fuel mixture continues burning, the gas spring 50 is compressed and the volume of the sub chamber 60 increases. For this reason, the rise of the pressure of the combustion chamber 5 and the sub chamber 60 is suppressed. In the embodiment shown in FIG. 3, the pressure of the combustion chamber 5 is held substantially constant.

If combustion of fuel continues further in the combustion chamber, the displacement of the sub chamber use piston 55 becomes maximum, then becomes smaller. The pressure of the gas chamber 61 is decreased and the displacement of the sub chamber use piston 55 returns to zero. That is, the sub chamber use piston 55 returns to a seated position. When the pressure of the combustion chamber 5 becomes less than the control pressure, the pressure of the combustion chamber 5 is reduced along with the progress of the crank angle.

In this way, the combustion pressure control system in the present embodiment can suppress the rise of the pressure of a combustion chamber when the pressure of the combustion chamber 5 reaches the control pressure and can perform control so that the pressure of the combustion chamber does not become higher than the pressure where abnormal combustion occurs.

FIG. 3 shows a graph of the pressure of a combustion chamber of Comparative Example 1 and Comparative Example 2. Comparative Example 1 and Comparative Example 2 are internal combustion engines which do not have the variable volume device of the present embodiment. The internal combustion engine fluctuates in the pressure of a combustion chamber in accordance with the ignition timing. The internal combustion engine has an ignition timing θmax where the output torque becomes maximum. Comparative Example 1 is a graph for when ignition is performed at the ignition timing θmax. By having the ignition performed at the ignition timing where the output torque becomes maximum, the pressure of the combustion chamber becomes high and the heat efficiency becomes the best. In this regard, if the ignition timing is advanced like in Comparative Example 1, the pressure of the combustion chamber becomes higher than the pressure where abnormal combustion occurs. The graph of Comparative Example 1 assumes that abnormal combustion does not occur. On the other hand, in an actual internal combustion engine, the ignition timing is delayed so that the maximum pressure of the combustion chamber becomes smaller than the pressure where abnormal combustion occurs.

In the internal combustion engine of Comparative Example 2, to avoid the occurrence of abnormal combustion, ignition is performed delayed from the ignition timing where the output torque becomes maximum. When delaying the ignition timing, the maximum pressure of a combustion chamber becomes smaller than the case where ignition is performed at an ignition timing where the output torque becomes maximum.

The internal combustion engine in the present embodiment can burn fuel when the pressure of a combustion chamber is maintained at less than the pressure where abnormal combustion occurs. It is possible to suppress the occurrence of abnormal combustion even if advancing the ignition timing. In particular, it is possible to suppress abnormal combustion even in an engine with a high compression ratio. Furthermore, it is possible to increase the time when the pressure of the combustion chamber is high. For this reason, the heat efficiency is improved over that of an internal combustion engine of Comparative Example 2 which delays the ignition timing. It is possible to increase the output torque. Further, it is possible to reduce the fuel consumption.

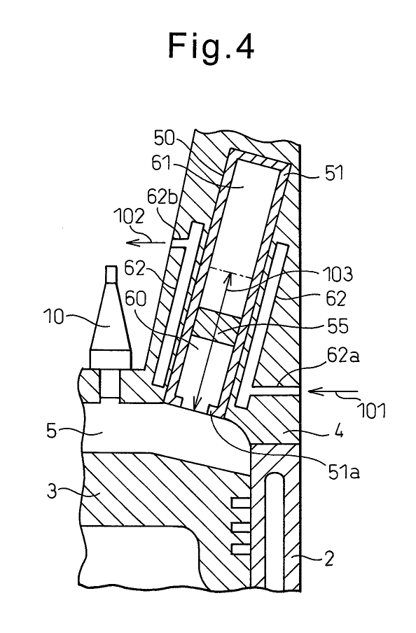

FIG. 4 shows an enlarged schematic cross-sectional view of a variable volume device including a first heating device in the present embodiment. The variable volume device in the present embodiment includes a heating device which is arranged around the tubular part and heats the wall surface of the tubular part in the region forming the space communicated with the combustion chamber when the movement member moves.

The first heating device in the present embodiment includes an exhaust passage 62 which is formed at the inside of the cylinder head 4. The exhaust passage 62 is supplied with high temperature exhaust gas. The exhaust passage 62 in the present embodiment is formed by a space in the cylinder head 4. The exhaust passage 62 is formed around the tubular member 51 along the shape of the tubular member 51. The exhaust passage 62 in the present embodiment is formed so as to surround the tubular member 51.

The exhaust passage 62 has an inlet part 62a and an outlet part 62b. The first heating device is formed so that part of the exhaust gas which flows out from the combustion chamber 5 to the engine exhaust passage, as shown by arrow 101, is supplied to the inlet part 62a. The inlet part 62a, for example, is connected to the exhaust port 9 which is formed at the cylinder head 4. The exhaust gas which runs through the exhaust passage 62, as shown by the arrow 102, flows out from the outlet part 62b. The exhaust gas which flows out from the outlet part 62b is again returned to the engine exhaust passage. The outlet part 62b, for example, is connected to the exhaust runner 19.

A sub chamber use piston 55 moves in a predetermined range when the pressure of the combustion chamber 5 becomes the control pressure or more. The region shown by the arrow 103 is the region forming the sub chamber 60 in at least part of the period when the sub chamber use piston 55 is moving. The exhaust passage 62 in the present embodiment is arranged around the region forming the sub chamber 60 shown by the arrow 103. The first heating device is formed so as to heat the wall surface of the region forming the sub chamber 60 in at least part of the period.

Due to the operation of the variable volume device in the present embodiment, the maximum pressure of the combustion chamber is suppressed. Due to the maximum pressure of the combustion chamber being suppressed, the maximum value of the combustion temperature is kept low. For this reason, it is possible to suppress movement of heat from the combustion gas to the cylinder block or the cylinder head. Due to the combustion temperature becoming lower, the cooling loss can be reduced.

In this regard, due to the operation of the variable volume device, the sub chamber use piston 55 moves to the opposite side from the side facing the combustion chamber 5. The combustion gas flows into the sub chamber 60 which has become larger in volume. The part of the tubular member 51 forming the wall surface of the sub chamber 60 in the peripheral direction contacts the combustion gas and increases in heat radiating area. Due to the sub chamber 60 becoming larger, the area which radiates heat to the cylinder head 4 through the tubular member 51 becomes larger. By heat being radiated from the sub chamber 60 to the cylinder head 4, the cooling loss becomes larger.

In the variable volume device of the present embodiment, when exhaust gas is supplied to the exhaust passage 62, the heat of the exhaust gas can be used to heat the wall surface of the tubular member 51. In particular, while the sub chamber use piston 55 is moving, it is possible to heat the wall surface of the tubular member 51 in the region forming the sub chamber 60. It is possible to reduce the temperature difference between the combustion gas which flows into the sub chamber 60 and the tubular member 51, so it is possible to keep heat from being radiated from the sub chamber 60 through the tubular member 51 to the cylinder head 4 while the volume of the sub chamber 60 becomes larger. As a result, it is possible to suppress cooling loss of the internal combustion engine and possible to suppress a drop in the torque which is output. Further, it is possible to suppress deterioration of the fuel consumption.

Further, the exhaust passage 62 of the first heating device is arranged around the region forming the space communicated with the combustion chamber 5 when the sub chamber use piston 55 moves. That is, it is formed so as to surround the region forming the sub chamber 60 shown by the arrow 103. Due to this configuration, it is possible to efficiently heat the wall surface of the tubular member 51 at the region forming the sub chamber 60. The heat of the combustion gas which flows into the sub chamber 60 can be efficiently kept from being transmitted to the tubular member 51.

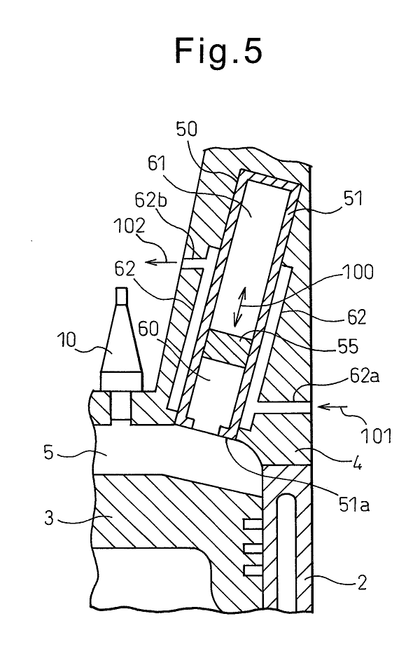

FIG. 5 shows an enlarged schematic cross-sectional view of a variable volume device including a second heating device in the present embodiment. The first heating device in the present embodiment comprises the exhaust passage 62 formed a distance away from the tubular member 51. As opposed to this, the second heating device comprises the exhaust passage 62 in contact with the tubular member 51. That is, the exhaust gas which runs through the exhaust passage 62 directly heats the tubular member 51 without going through the cylinder head 4. By employing the configuration where the heating device contacts the tubular member in this way, it is possible to improve the heating efficiency when heating the tubular member.

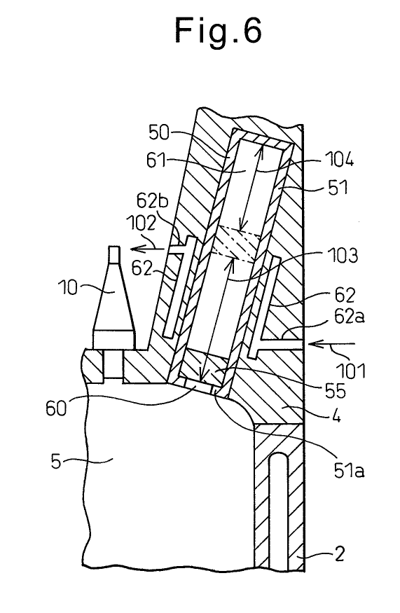

FIG. 6 shows an enlarged schematic cross-sectional view of a variable volume device including a third heating device in the present embodiment. The third heating device in the present embodiment has an exhaust passage 62 which is formed around the tubular member 51. The exhaust passage 62 of the third heating device is formed avoiding the surroundings of the region continuously forming the gas chamber 61 while the sub chamber use piston 55 is moving. The arrow 104 shows the region forming the gas chamber 61 when the sub chamber use piston 55 rises to the top end. The third heating device is configured not formed with the exhaust passage 62 around the region shown by the arrow 104. That is, the exhaust passage 62 is formed avoiding the region around the region forming the gas chamber 61 at all times while the sub chamber use piston 55 is moving.

In variable volume device in the present embodiment, the gas chamber 61 is closed while the sub chamber use piston 55 is moving. In this regard, if the heating device heats the gas which is sealed in the gas chamber 61, the pressure of the gas chamber 61 rises. That is, the control pressure ends up rising.

By arranging the heating device avoiding the surroundings of the region continuously becoming the gas chamber 61 while the sub chamber use piston 55 is moving, it is possible to keep part forming the wall surface of the gas chamber 61 from being heated. It is therefore possible to promote radiation of heat from the gas chamber 61. In particular, it is possible to keep the heat generated from the heating device from heating the gas at the inside of the gas chamber 61 through the cylinder head 4. When the gas chamber 61 is closed, it is possible to keep the temperature of the gas at the inside of the gas chamber 61 from rising and the control pressure from rising. Further, when using the pressure changing device to adjust the pressure of the gas chamber 61, it is possible to easily adjust the pressure.

Note that, the variable volume device in the present embodiment has a pressure changing device connected to it, but the invention is not limited to this. The present invention can also be applied to a variable volume device to which no pressure changing device is connected.

Further, the third heating device in the present embodiment is formed avoiding the region around the seated sub chamber use piston 55. FIG. 6 shows the state where the sub chamber use piston 55 is engaged with the engagement part 51a and is seated at the bottom of the tubular member 51. The sub chamber use piston 55 forms the wall surface of the combustion chamber 5 when engaged with the engagement part 51a. The sub chamber use piston 55 contacts the intake air or air-fuel mixture in the suction stroke. For this reason, if the temperature of the sub chamber use piston 55 is maintained high, the temperature of the intake air or air-fuel mixture rises. If the temperature of the intake air or air-fuel mixture rises, the charging efficiency falls, so the problem of easy occurrence of knocking or other abnormal combustion occurs.

By having the heating device be formed avoiding the region around the region where the sub chamber use piston 55 is seated, it is possible to keep the radiation of heat from the sub chamber use piston 55 from being obstructed and possible to keep the temperature of the intake air or air-fuel mixture from rising. In this way, it is possible to suppress a drop in the charging efficiency while suppress a drop in the cooling loss.

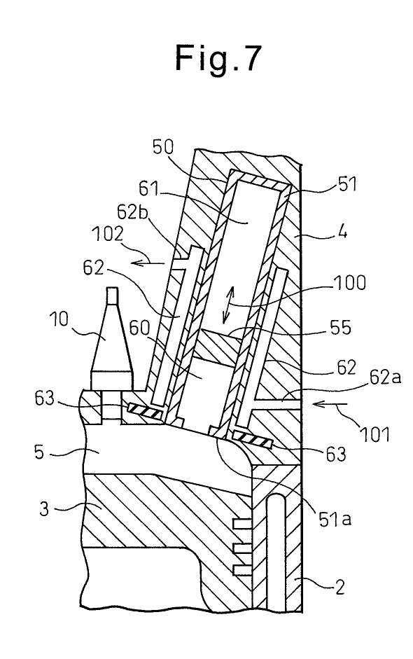

FIG. 7 shows an enlarged schematic cross-sectional view of a variable volume device including a fourth heating device in the present embodiment. The fourth heating device has a heat insulating structure which is formed between the exhaust passage 62 and the combustion chamber 5. The heat insulating structure of the present embodiment has the function of suppressing the movement of heat from the heating device to the inside of the combustion chamber 5.

In the fourth heating device of the present embodiment, a heat insulating member 63 is arranged between the exhaust passage 62 and the combustion chamber 5. The heat insulating member 63 is formed around the tubular member 51 along the shape of the tubular member 51. The heat insulating member 63 in the present embodiment is formed in a ring shape. As the heat insulating member 63, for example, one can be formed by a material having a heat conductivity smaller than the cylinder head 4. The cylinder head 4, for example, can be formed by a ferrous metal, aluminum alloy, or other metal. For this reason, the cylinder head 4 has a high heat conductivity. The heat insulating member 63, for example, can be formed from a resin. Further, in particular, among the resins, a foamed resin with a small heat conductivity is preferable.

As explained above, in the suction stroke, the temperature at the wall surface of the combustion chamber is preferably low. By forming a heating insulating structure between the heating device and the combustion chamber, it is possible to keep the heating device from heating the wall surface of the combustion chamber. In the fourth heating device, the transfer of heat from the exhaust passage 62 toward the wall surface of the combustion chamber 5 can be suppressed. As a result, it is possible to keep the air-fuel mixture or air which flows into the combustion chamber from being heated in the suction stroke and possible to keep the charging efficiency from dropping.

The heat insulating structure of the variable volume device including the fourth heating device of the present embodiment includes a heat insulating member, but the invention is not limited to this. As the heat insulating structure, it is possible to employ any structure which suppresses movement of heat from the heating device to the combustion chamber. For example, as the heat insulating structure, instead of a heat insulating member, a cavity which is internally reduced in pressure, then closed may also be formed. Further, a cavity which is internally filled with a gas may also be formed. By forming such a closed space as well, it is possible to arrange a part with a smaller heat conductivity than the cylinder block and form a heat insulating structure.

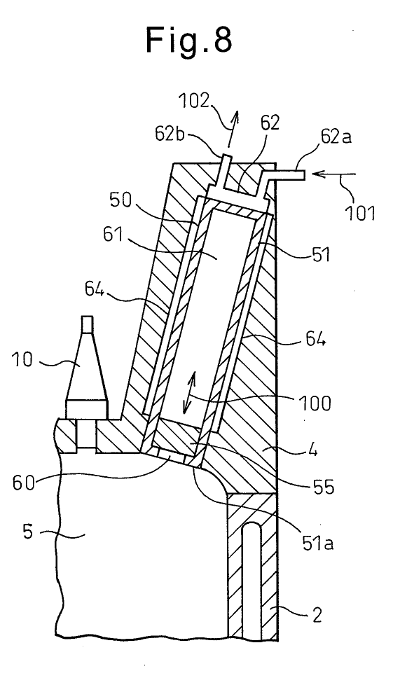

FIG. 8 is an enlarged schematic cross-sectional view of a variable volume device including a fifth heating device in the present embodiment. In the fifth heating device, the exhaust passage 62 which functions as the heating device is formed at the top surface of the tubular member 51. The exhaust passage 62 is formed at the end face of the tubular member 51 at the opposite side from the side facing the combustion chamber 5. At the side face of the tubular member 51 in the peripheral direction, a heat insulating structure is formed.

The variable volume device including the fifth heating device is formed with a cavity 64 serving as a heat insulating structure. The cavity 64 is a closed space which is formed around the tubular member 51 along the side surface of the tubular member 51. The cavity 44 contacts the tubular member 51. Further, the cavity 44 is internally reduced in pressure. The cavity is not limited to this. For example, a closed space which is filled with any gas may also be formed.

In the fifth heating device, it is possible to run exhaust gas through the exhaust passage 62 so as to heat the tubular member 51. Around the tubular member 51, a cavity 64 is formed as the heat insulating structure, so heat can be kept from being radiated from the tubular member 51 to the cylinder head 4. As a result, it is possible to make the heat of the exhaust passing through the exhaust passage 62 move along the side wall of the tubular member 51. The tubular member 51 can be maintained at a high temperature. When the sub chamber use piston 55 moves, it is possible to heat the wall surface of the tubular member 51 at the region forming the sub chamber 60. As a result, the heat of the combustion gas can be kept from moving through the tubular member 51 to the cylinder head 4.

The fifth heating device is comprised of the exhaust passage 62 formed at the top surface of the tubular member 51. That is, a heating device is arranged at a position separated from the combustion chamber 5. For this reason, in the region near the combustion chamber 5, there is no need to form a device of a complicated configuration. It is also possible to easily form a variable volume device including a heating device. Further, the productivity when producing a variable volume device is improved.

In the variable volume device including the fifth heating device, the cavity 64 forming the heat insulating structure contacts the tubular member 51, but the invention is not limited to this mode. The cavity 64 may be formed inside of the cylinder head 4 separated from the tubular member 51.

Further, in the variable volume device including the fifth heating device, the cavity 64 is formed avoiding the region around the seated sub chamber use piston 55. By employing this configuration, it is possible to improve the heat radiating property of the sub chamber use piston 55 when the sub chamber use piston 55 is seated. It is possible to keep the sub chamber use piston 55 from being maintained at a high temperature and keep the charging efficiency from dropping.

One exhaust passage of the heating device of the present embodiment is formed at the cylinder head, but the invention is not limited to this. A plurality of exhaust passages may also be formed around the tubular part.

The above-mentioned heating device uses the heat of the exhaust gas which flows out from the combustion chamber to heat the tubular member. Due to this configuration, it is possible to utilize the heat which is discharged to the outside so as to heat the wall surface of the sub chamber. The heating device is not limited to this. It is possible to employ any device which heats the tubular member. For example, the heating device may include an electric heater.

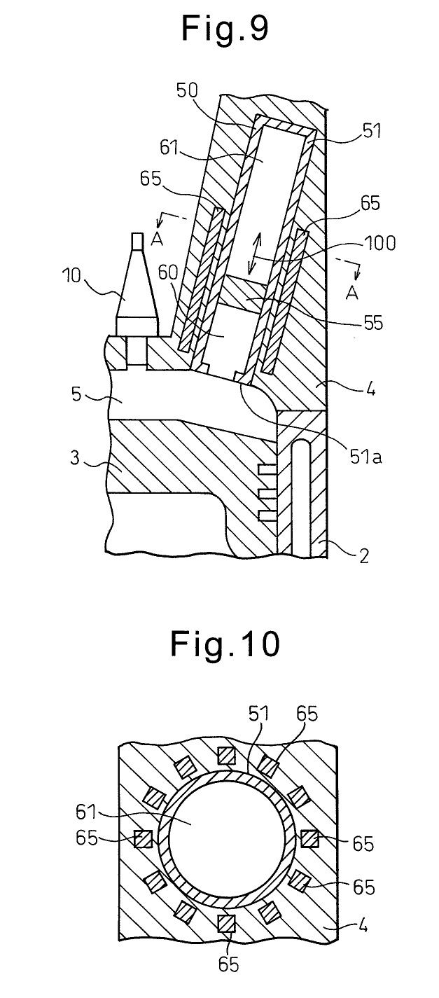

FIG. 9 is an enlarged schematic cross-sectional view of a variable volume device which includes a sixth heating device in the present embodiment. The sixth heating device in the present embodiment includes electric heaters 65. These electric heaters 65 are connected to a power source. The power source of the electric heaters 65 is controlled by an electronic control unit 31. The electric heaters 65 are formed so as to extend in the direction of movement of the sub chamber use piston 55. The electric heaters 65 are arranged so as to heat the wall surface of the tubular member in the region becoming the sub chamber 60 while the sub chamber use piston 55 moves.

FIG. 10 shows another schematic cross-sectional view of a variable volume device including the sixth heating device. FIG. 10 is a arrowed-cross-sectional view along the A-A line in FIG. 9. In the present embodiment, a plurality of the electric heaters 65 are arranged around the tubular member 51. The electric heaters 65 in the present embodiment are formed into rod shapes. The electric heaters 65 are arranged at equal intervals so as to surround the tubular member 51.

While the electric heaters of the sixth heating device in the present embodiment are formed into rod shapes, the invention is not limited to this. It is possible to employ any electric heaters which heat the tubular member. For example, a single plate-shaped heater may also be arranged surrounding the tubular member.

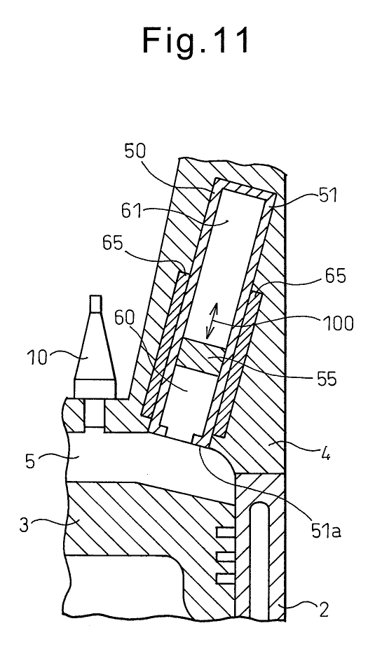

FIG. 11 is an enlarged schematic cross-sectional view of a variable volume device which includes a seventh heating device in the present embodiment. The seventh heating device in the present embodiment includes a plurality of the electric heaters 65. Each of the electric heaters 65 is in contact with the tubular member 51. By employing this configuration, it is possible to improve the heating efficiency when heating the tubular member.

The above plurality of embodiments may be combined with each other. For example, an electric heater may be arranged around the tubular part in addition to the exhaust passage. The spring device of the variable volume device in the present embodiments includes a gas spring, but the spring device is not limited to this. It is possible to include any member which presses against the movement member. For example, the spring device may also include a mechanical spring such as a coil spring.

In the present embodiments, the explanation was given with reference to an internal combustion engine mounted in an automobile as an example, but the invention is not limited to this. The present invention may be applied to any internal combustion engine.

In the above drawings, the same or corresponding parts are assigned the same reference signs. Note that the above embodiments are illustrations and do not limit the invention. Further, in the embodiments, the changes shown in the claims are included.

### REFERENCE SIGNS LIST

1 engine body
4 cylinder head
5 combustion chamber
31 electronic control unit
50 gas spring
51 tubular member
51a engagement part
55 sub chamber use piston
60 sub chamber
61 gas chamber
62 exhaust passage
63 heat insulating member
64 cavity
65 electric heater

1. An internal combustion engine including
a variable volume device which includes a spring device which has elasticity and which, when the pressure of a combustion chamber reaches a predetermined control pressure, uses the change in pressure of the combustion chamber as a drive source so that the spring device is compressed whereby the volume of a space communicated with the combustion chamber changes, wherein
the spring device includes a tubular part which communicates with the combustion chamber and a movement member which is arranged movably inside the tubular part, which movement member divides a space at the inside of the tubular part, whereby a space is formed communicated with the combustion chamber,
the variable volume device includes a heating device which is arranged around the tubular part, and
the heating device is formed so as to be able to heat the region, in the wall surface of the tubular part, forming the space communicated with the combustion chamber when the movement member moves.

2. An internal combustion engine as set forth in claim 1, wherein the heating device is arranged around the region forming the space communicated with the combustion chamber when the movement member moves.

3. An internal combustion engine as set forth in claim 1, wherein
the spring device has a gas chamber which is formed at a side opposite to the side facing the combustion chamber by the movement member dividing a space inside of the tubular part,
the movement member is pressed against by pressurized gas being sealed in the gas chamber, and
the heating device is formed avoiding the surroundings of the region continuously forming the gas chamber during the period of movement of the movement member.

4. An internal combustion engine as set forth in claim 1, wherein the variable volume device has a heat insulating structure which is arranged between the heating device and the combustion chamber and which suppresses movement of heat from the heating device to the inside of the combustion chamber.

5. An internal combustion engine as set forth in claim 1, wherein
the variable volume device is arranged inside of the cylinder head which includes the top face of each combustion chamber,
the tubular part is fastened to the cylinder head, and
the heat insulating structure includes a heat insulating member with a smaller heat conductivity than the cylinder head or a closed space with a cavity inside it.
